(19) United States
(12) Patent Application Publication
(10) Pub. No.: US 2007/0223743 A1
(43) Pub. Date: Sep. 27, 2007

(54) Electro-Acoustic Converter and Electronic Device Using the Same

(76) Inventors: Kazuki Honda, Mie (JP); Hiroshi Yano, Mie (JP); Takeshi Shimokawatoko, Mie (JP); Kazuya Yamasaki, Osaka (JP); Kazutaka Kubo, Mie (JP); Masahide Sumiyama, Mie (JP)

Correspondence Address: WENDEROTH, LIND & PONACK L.L.P., 2033 K. STREET, NW, SUITE 800, WASHINGTON, DC, 20006, US

(21) Appl. No.: 11/587,412

(22) PCT Filed: Jun. 17, 2005
(86) PCT No.: PCT/JP05/11119

§ 371 Date: Oct. 24, 2006

(30) Foreign Application Priority Data
Jun. 23, 2004 (JP) 2004-184720

(51) Int. Cl. H04R 1/02

(52) U.S. Cl. 381/152

(57) ABSTRACT

Electro-acoustic converter (35) such as a speaker includes frame (26) attached to magnetic circuit member (24), diaphragm (27) attached to frame (26), voice coil (28) attached to this diaphragm (27) and having a part of which disposed in magnetic gap (25) in magnetic circuit member (24), terminal (30) made by bending a metal plate and being brought into contact with a power supply unit of an electronic device in which electro-acoustic converter (35) is installed by utilizing a spring pressure of this metal plate, and stopper (29) restricting bending of the metal plate forming this terminal (30) within a reversible limit of its metal material.

### TECHNICAL FIELD

The present invention relates to electro-acoustic converters used in a range of acoustic equipment and information communications equipment, and electronic devices such as mobile phones and game machines that employ such electro-acoustic converters.

### BACKGROUND ART

A prior art is described with reference to FIGS. 8 to 12. FIGS. 8 to 10 are sectional views of a conventional electro-acoustic converter used as a speaker or receiver in an electronic device such as a mobile phone. FIGS. 11 and 12 are sectional views of this electro-acoustic converter installed in an electronic device such as a mobile phone.

As shown in FIG. 8, internal magnetic circuit member 304 is configured by sandwiching magnetized magnet 301 between upper plate 302 and yoke 303. Magnetic circuit member 304 is press-fitted and attached by adhesive to resin frame 306 into which a part of terminal 310 is molded, with yoke 303 of magnetic circuit member 304 contacting resin frame 306.

Diaphragm 307 is attached to the periphery of this frame 306. Voice coil 308 for driving diaphragm 307 is attached to this diaphragm 307 in a way such that voice coil 308 is fitted into magnetic gap 305. A lead of this voice coil 308 is then soldered to one end of terminal 310. Lastly, this terminal 310 is half-folded roughly at the center such that terminal 310 does not protrude outside of the circumference of frame 306. The other end of terminal 310 acts as a feed terminal for the electronic device into which the electro-acoustic converter is installed.

This terminal 310 is formed by bending a single conductive metal plate. Terminal 310 contacts a power supply unit of the electronic device by means of the spring pressure of this metal plate. A tip of the metal plate of terminal 310 is bent inward to create stopper 309 so that the bending of this terminal 310 does not exceed a reversible limit range of its metal material.

FIGS. 9 and 10 are sectional views illustrating the states of terminal 310. If the state of terminal 310 shown in FIG. 8 is the top dead point, FIG. 9 shows the state where terminal 310 is at the bottom dead point. FIG. 10 shows the state where stopper 309 has deformed and collapsed due to a further excessive force applied to terminal 310 at the bottom dead point.

FIGS. 11 and 12 are sectional views of electronic device 380 such as a mobile phone in which speaker 335, i.e., the above electro-acoustic converter, is installed. In FIGS. 11 and 12, electronic device 380 includes outer case 370 and display module 360.

FIG. 11 illustrates the state where terminal 310 is bent to some extent and appropriate spring pressure is applied to the power supply unit of the electronic device. In FIG. 12, the power supply unit of the electronic device pushes and deforms terminal 310 due to an external factor such as an impact applied by dropping the mobile phone, and terminal 310 reaches the bottom dead point. Then, a further excessive force is applied to terminal 310, as a result of which stopper 309 is deformed and collapsed. In this case, stopper 309 is deformed to a point that exceeds the reversible limit of its metal material. Accordingly, if an impact of this nature is once applied, stopper 309 does not return to its original position even if the applied pressure is released.

The prior art related to the present invention is typically disclosed in Japanese Patent Application No. 2003-37890.

There is a growing demand for more reliable electronic devices such as mobile phones. It is thus indispensable to improve the reliability of electro-acoustic converters installed in electronic devices in order to improve the reliability of these electronic devices.

Against such a background, a disadvantage of the prior art is further described below. A conventional electro-acoustic converter of this type, i.e., speaker 335 or receiver, is coupled by contact with the power supply unit of electronic device 380 by utilizing the spring pressure of a metal terminal of its terminal 310.

However, stopper 309 of terminal 310 may deform if a large dimension is set for holding down speaker 335 to install it to electronic device 380. This may result in the spring pressure of the metal terminal of terminal 310 exceeding its reversible limit. Still more, if electronic device 380 such as a mobile phone is accidentally dropped, stopper 309 of terminal 310 collapses due to an excessive impact, and the spring pressure of the metal terminal of terminal 310 may exceed its reversible limit. Although stopper 309 possesses spring pressure because it is made of the same material as the metal terminal, stopper 309 deforms permanently if deformation also exceeds the reversible limit of the spring pressure of stopper 309.

If this happens, the spring pressures of terminal 310 and stopper 39 fall, and coupling by contact with the power supply unit of electronic device 380 becomes unreliable. Consequently, a contact failure occurs and signals are interrupted if an impact or vibration is applied to electronic device 380.

This disadvantage is common to resin stoppers integrally molded with a resin frame in addition to the type of formation of the stopper on the terminal. In this type, a resin stopper is damaged by impact, and the spring pressure of the metal terminal of terminal 310 exceeds its reversible limit.

For the above reason, a structure that avoids loss of spring pressure of the terminal is needed to prevent interruption of speaker signals even if an impact or vibration is applied to the electronic device.

### SUMMARY OF THE INVENTION

An electro-acoustic converter of the present invention includes a frame attached to a magnetic circuit member, a diaphragm attached to an outer periphery of this frame, a voice coil attached to this diaphragm and having a part of which disposed in a magnetic gap in the magnetic circuit member, a terminal to which a lead of this voice coil is coupled, and a stopper provided on the magnetic circuit member. The terminal is made by bending a single conductive metal plate, and the spring pressure of this metal plate is utilized for contacting the power supply unit of the electronic device in which the electro-acoustic converter is installed. The stopper is configured with a protrusion made of the same material as the magnetic circuit member so as to restrict bending of the metal plate forming the terminal within the reversible limit of its metal material.

An electronic device of the present invention employs an electro-acoustic converter, and this electro-acoustic converter has the above structure. This structure prevents loss of the spring pressure of the terminal and thus offers an excellent electro-acoustic converter and electronic device using the same which can reliably supply signals to the electro-acoustic converter.

### BRIEF DESCRIPTION OF THE DRAWINGS

FIG. 1 is a sectional view of a speaker in accordance with a first exemplary embodiment of the present invention.

FIG. 2 is a sectional view illustrating the state where a terminal of the speaker in FIG. 1 is deformed by an external force.

FIG. 3 is a perspective view of the speaker in FIG. 1.

FIG. 4 is a sectional view of a speaker in accordance with a second exemplary embodiment of the present invention.

FIG. 5 is a sectional view of another speaker in accordance with the second exemplary embodiment of the present invention.

FIG. 6 is a sectional view of a key part of an electronic device in accordance with a third exemplary embodiment of the present invention.

FIG. 7 is a sectional view of a key part of a terminal of a speaker installed in the electronic device in FIG. 6, illustrating the state where the terminal is deformed by an external force.

FIG. 8 is a sectional view of a conventional speaker.

FIG. 9 is a sectional view of a terminal of the speaker in FIG. 8 which is deformed by an external force.

FIG. 10 is a sectional view of the terminal in FIG. 9 deformed by an excessive external force.

FIG. 11 is a sectional view of a key part of a conventional electronic device.

FIG. 12 is a sectional view of a key part of a terminal of the speaker installed in the electronic device in FIG. 11, illustrating the state where the terminal is deformed by an external force.

### REFERENCE MARKS IN THE DRAWINGS

21, 211 Magnet
22, 221 Upper plate
23 Yoke
24 Magnetic circuit member
25 Magnetic gap
26 Frame
27 Diaphragm
28 Voice coil
29 Stopper
30 Terminal
35 Electro-acoustic converter (speaker)
40 Electronic circuit
60 Display module
70 Outer case
80 Electronic device (mobile phone)
231 Lower plate

### DETAILED DESCRIPTION OF THE PREFERRED EMBODIMENTS

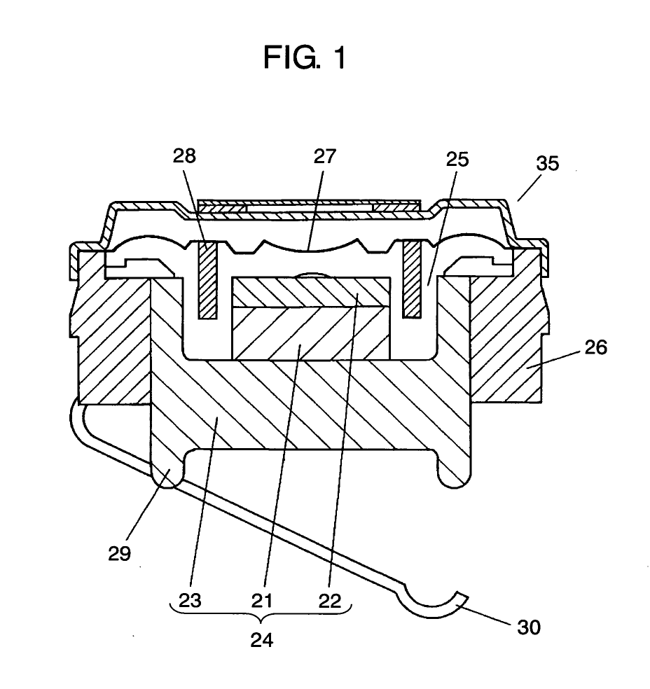

First, the structural points of an electro-acoustic converter of the present invention and an effect unique to the present invention are described with reference to drawings. In FIG. 1, speaker 35, which is the electro-acoustic converter, includes frame 26 attached to magnetic circuit member 24, diaphragm 27 attached to an outer periphery of this frame 26, voice coil 28 attached to this diaphragm 27 and having a part of which disposed in magnetic gap 25 of magnetic circuit member 24, terminal 30 coupled to a lead of this voice coil 28, and stopper 29 which is a protrusion made of the same material as magnetic circuit member 24 and is disposed on this magnetic circuit member 24. Terminal 30 is made by bending a single conductive metal plate and the spring pressure of this metal plate is utilized to bring terminal 30 into contact with a power supply unit of the electronic device in which the electro-acoustic converter is installed. Stopper 29 restricts bending of this metal plate forming terminal 30 to within a reversible limit of its metal material.

Stopper 29, as described later, touches a component of the electronic device, such as a printed circuit board where an electronic circuit of the electronic device is mounted, and restricts further bending of terminal 30 that exceeds the reversible limit of the metal material forming terminal 30 when the dimension for holding down speaker 35 for installing speaker 35 in the electronic device is set large or an excessive impact is applied to the electronic device in which speaker 35 is installed.

Accordingly, stopper 29 is reinforced in the above structure so as to limit the bending of terminal 30 to within the reversible limit of the metal material. In other words, stopper 29 of terminal 30 is made of a material resistant to impacts instead of making it such by bending a metal plate, or using resin or other materials weak to pressurized deformation or impact.

With respect to the material of this stopper, a hard metal material which is used for magnetic circuit member 24, such as yoke 23 and lower plate, is formed into a protrusion. Accordingly, stopper 29 functions as a stopper against deformation of terminal 30 without stopper 29 itself being deformed or destroyed.

Accordingly, stopper 29 does not deform or collapse even if a large holding dimension is set for speaker 35 at mounting speaker 35 to an electronic device such as a mobile phone or an excessive impact is applied to terminal 30 due to accidental dropping of the electronic device. Therefore, the spring pressure of terminal 30 does not reduce because the spring pressure of the metal terminal of terminal 30 does not exceed its reversible limit.

Terminal 30 can thus always maintain strong spring pressure. This achieves reliable coupling by contact with the power supply unit of the electronic device in which speaker 35 is installed. Since no contact failure occurs even if impacts or vibrations are applied to the electronic device, a reliable transmission is achieved without any interruption of signals. The reliability of electronic devices such as mobile phones can thus be improved.

Exemplary embodiments of the present invention are further detailed below.

### First Exemplary Embodiment

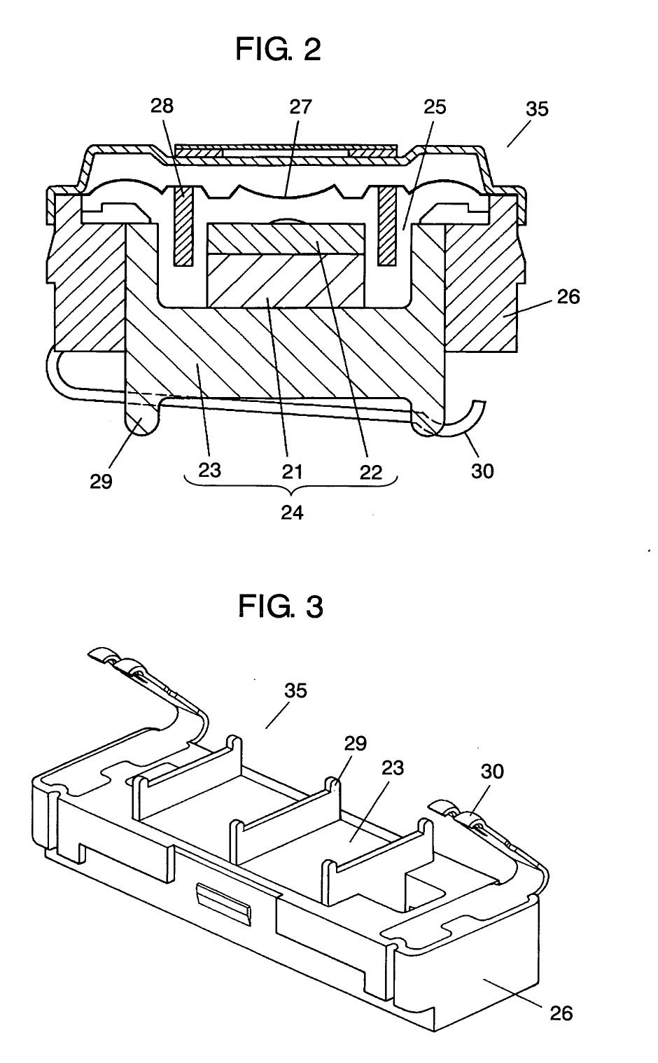

FIGS. 1 to 3 are sectional views of the speaker, which is the electro-acoustic converter, in the first exemplary embodiment of the present invention. The electro-acoustic converter is applied to a slim rectangular speaker. FIG. 1 is a sectional view of the electro-acoustic converter (speaker) in the first exemplary embodiment. FIG. 2 is a sectional view illustrating the state where the terminal in FIG. 1 is stopped at its lowest position by the stopper. FIG. 3 is a perspective view of the state in FIG. 1.

As shown in FIGS. 1 to 3, internal magnetic circuit member 24 is configured by sandwiching magnetized magnet 21 between upper plate 22 and yoke 23 with stopper 29 on its back. Magnetic circuit member 24 is press-fitted and attached by adhesive to resin frame 26 into which a part of terminal 30 is molded, with yoke 23 of magnetic circuit member 24 contacting resin frame 26.

Then, diaphragm 27 is attached to the periphery of this frame 26. Voice coil 28 for driving diaphragm 27 is attached to this diaphragm 27 in a way such that voice coil 28 is fitted into magnetic gap 25. A lead of this voice coil 28 is then soldered to one end of terminal 30. Lastly, this terminal 30 is half-folded roughly at the center such that terminal 30 does not protrude outside of the circumference of frame 26. The other end of terminal 30 acts as a feed terminal for the electronic device.

Here, stopper 29 is provided on the back of yoke 23 of magnetic circuit member 24 so as to restrict bending of the metal plate forming terminal 30 to within a reversible limit of its metal material. This stopper 29 is made of a hard metal material same as that for yoke 23. This structure enables stopper 29 to fulfill its function against deformation of terminal 30 without stopper 29 itself being deformed or destroyed

When this yoke 23 is formed, stopper 29 may be integrally formed using the same hard metal material as yoke 23. Integral and simultaneous formation improves the productivity of yoke 23 with stopper 29. Alternatively, this stopper 29 may be fabricated separately, and attached to yoke 23.

In this exemplary embodiment, a shape of stopper 29 provided on the back of yoke 23 is a wall-like protrusion formed on both ends and at their center of rectangular yoke 23, as shown in FIG. 3. Small protrusions are further provided on both ends of each of these wall-like protrusions. In other words, stopper 29 is provided at three points on the back of yoke 23. However, it is apparent that the shape of this stopper 29 is not limited to this shape as long as it can function as a stopper.

With this structure, terminal 30 is bent to a certain extent and retained in the state where an appropriate spring pressure is applied to the power supply unit of the electronic device when speaker 35 is installed in the electronic device such as a mobile phone. Still more, even if the speaker is strongly held down for installation, a component in the electronic device, such as a printed circuit board where the electronic circuit of the electronic device is mounted, touches stopper 29, and thus terminal 30 does not move further.

If the electronic device such as a mobile phone is accidentally dropped and an excessive impact is applied to terminal 30, stopper 29 produces an effect of preventing deformation exceeding the reversible limit of the metal material or collapse. Accordingly, the spring pressure of the metal terminal of terminal 30 does not exceed its reversible limit, preventing loss of spring pressure of terminal 30.

Terminal 30 can thus always maintain strong spring pressure. This achieves reliable coupling by contact with the power supply unit of the electronic device. Since no contact failure occurs even if impacts or vibrations are applied to the electronic device, a reliable transmission is achieved without any interruption of signals. The reliability of electronic devices such as mobile phones can thus be improved.

Stopper 29 may also be covered with an insulator. This is to avoid occurrence of shorting even if both of a pair of terminals 30, as shown in FIG. 3, are deformed and both touch stoppers 29 due to an excessive force applied such as by drop impact, although stoppers 29 do not directly contact terminal 30 in normal use. In addition, shorting can be prevented even if stopper 29 contacts the electronic circuit of the electronic device due to an excessive force applied such as by a drop impact.

Other than stopper 29 in the form of a protrusion, as shown in FIG. 1, stopper 29 can be configured by making a rear face of magnetic circuit member 24 protrude from frame 26. More specifically, the entire rear face of magnetic circuit member 24 can be made thicker, or the position of magnetic circuit member 24 can be shifted to the rear side relative to frame 26.

### Second Exemplary Embodiment

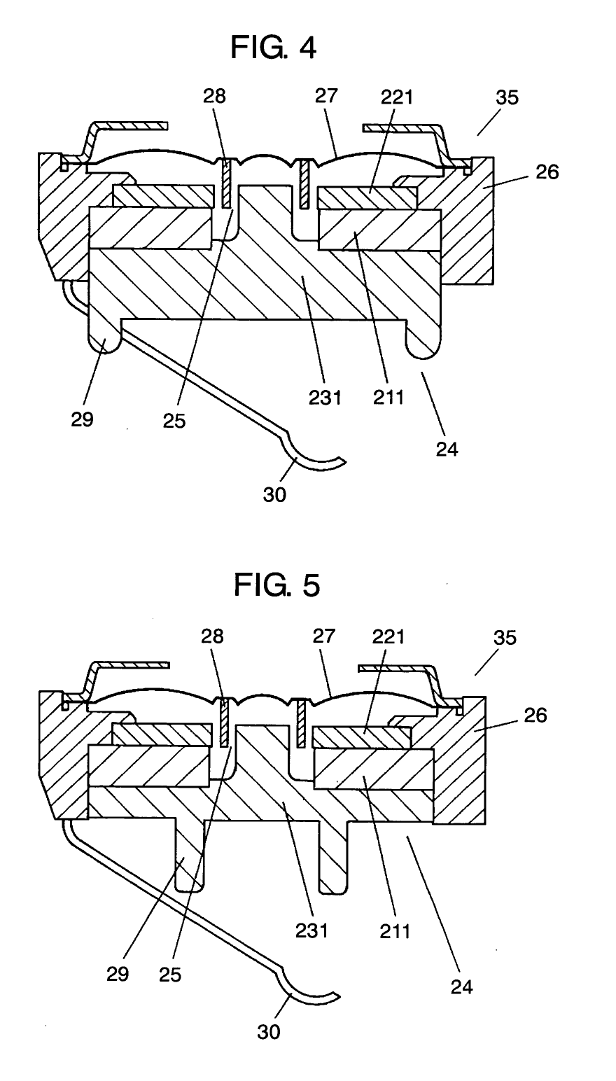

FIGS. 4 and 5 are sectional views of a speaker in the second exemplary embodiment of the present invention. Only the points different from the first embodiment are described in the second exemplary embodiment.

As shown in FIGS. 4 and 5, external magnetic circuit member 24 is configured by sandwiching magnetized magnet 211 between upper plate 221 and lower plate 231 with stopper 29 on its back. Stopper 29 on the back of lower plate 231 of this external magnetic circuit member 24 restricts a bending range of terminal 30. Stopper 29 is integrally formed with lower plate 231.

This structure prevents deformation of terminal 30 in an electro-acoustic converter employing the external magnetic circuit in addition to the electro-acoustic converter employing internal magnetic circuit. Accordingly, the reliability of electronic devices such as mobile phones can be improved.

As shown in FIG. 4, the shape of this stopper 29 is a wall-like protrusion formed on both ends and at their center of rectangular lower plate 231. Small protrusions are further provided on both ends of each of these wall-like protrusions, same as yoke 23 described in the first exemplary embodiment. In other words, stopper 29 is provided at three points on the back of lower plate 231.

However, stopper 29 is not limited to this shape. Stopper 29 may be a columnar protrusion, as shown in FIG. 5. Any shape is applicable as long as stopper 29 can function as a stopper.

### Third Exemplary Embodiment

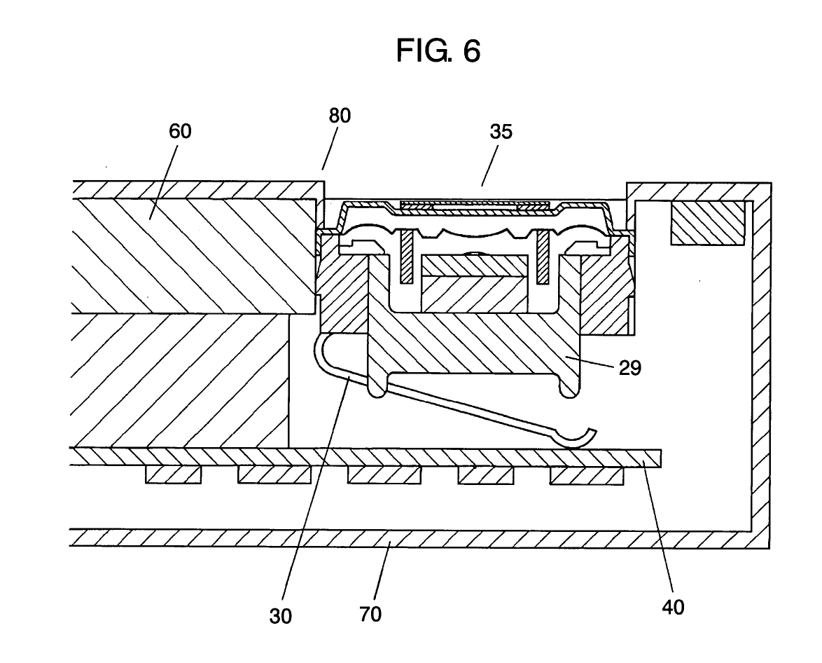

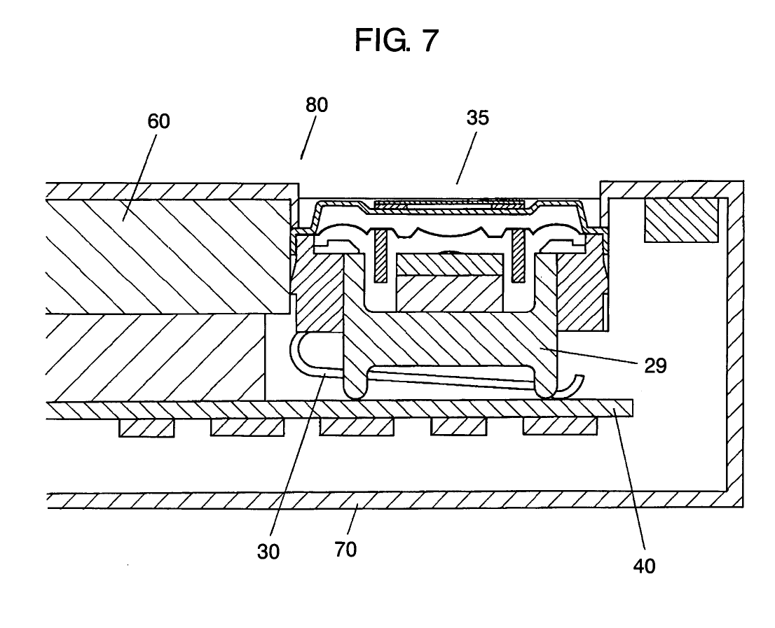

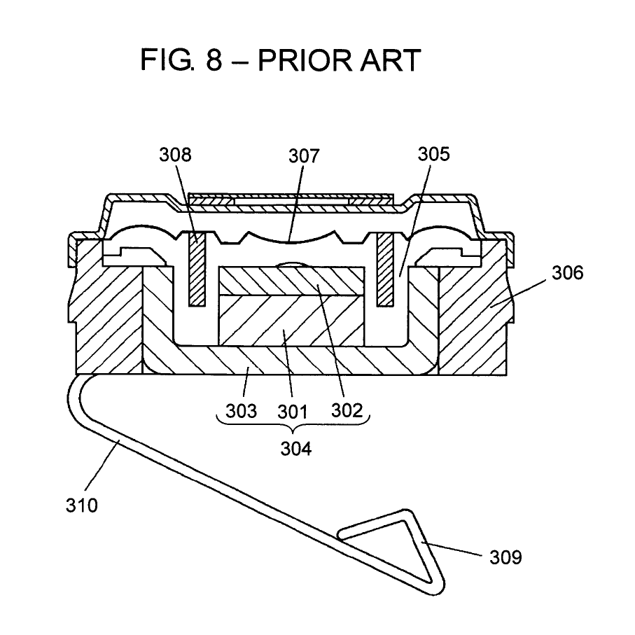

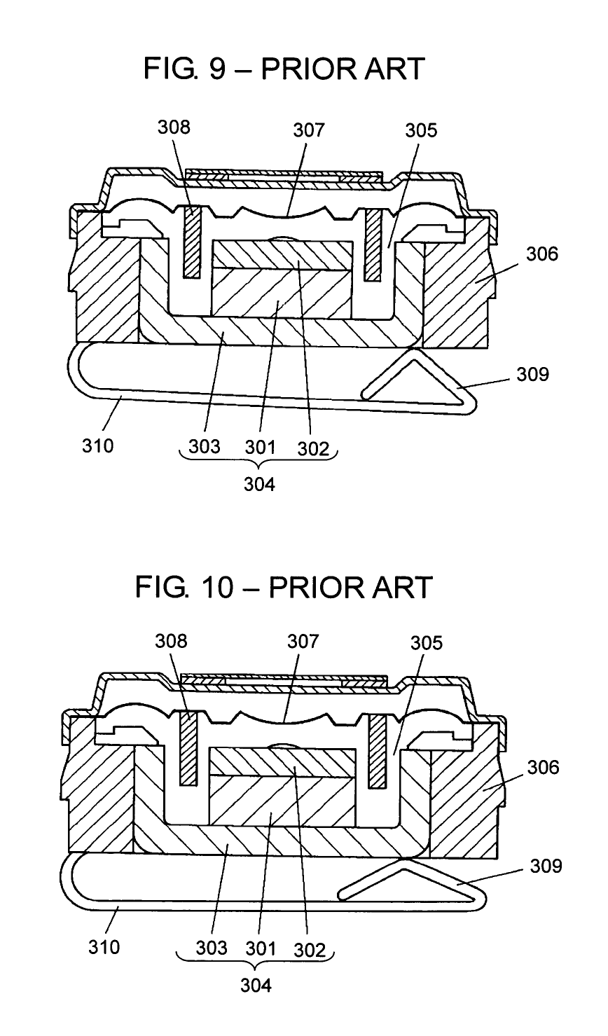

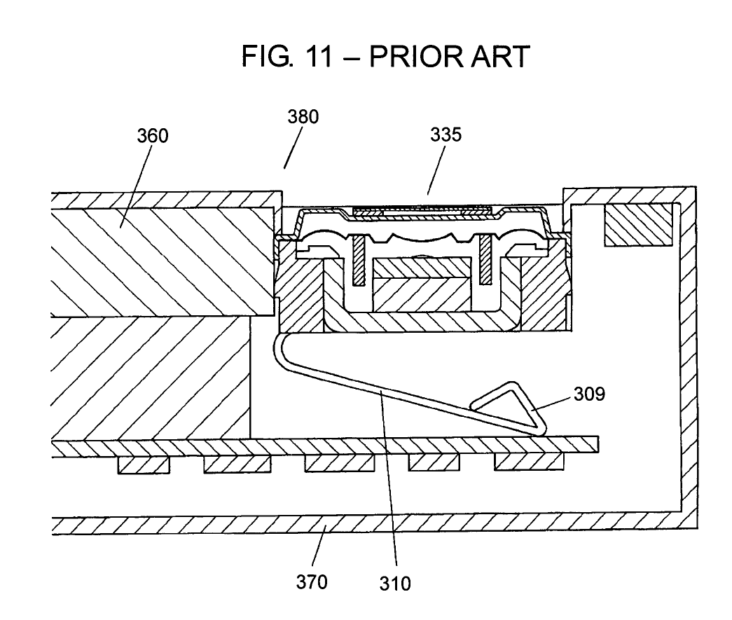

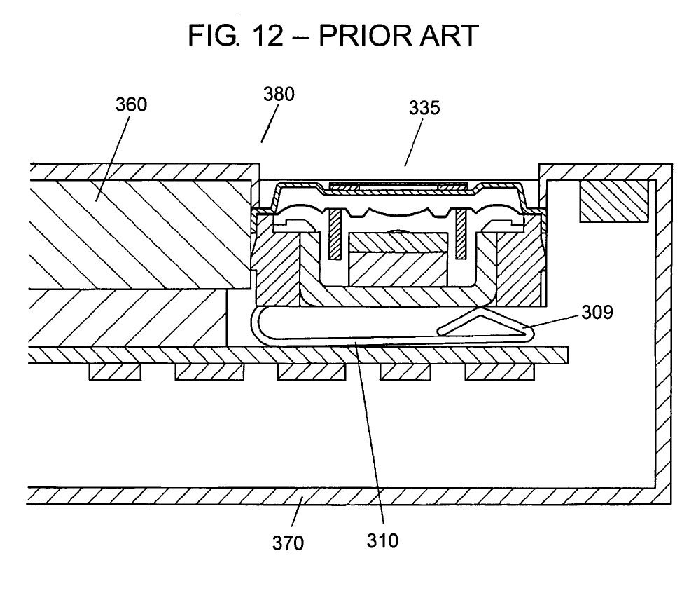

FIGS. 6 and 7 are sectionals views of a key part of a mobile phone, an electronic device, in the third exemplary embodiment of the present invention.

Speaker 35 described in the above first and second exemplary embodiments is installed in mobile phone 80 shown in FIGS. 6 and 7. This mobile phone 80 includes components and modules such as speaker 35, electronic circuit 40, and display module 60, such as an LCD, inside outer case 70, configuring the key part of mobile phone 80. Power is supplied to operate speaker 35 by bringing terminal 30 of speaker 35 and electronic circuit 40 of mobile phone 80 into contact by applying spring pressure.

In this structure, as shown in FIG. 7, stopper 29 produces an effect of preventing permanent deformation or collapse of terminal 30 even if a large dimension is set for holding down speaker 35 to install speaker 35 in mobile phone 80 or when an excessive impact is applied to terminal 30 by accidentally dropping mobile phone 80. More specifically, electronic circuit 40 in mobile phone 80 touches stopper 29 to avoid permanent deformation or collapse of terminal 30. Accordingly, the spring pressure of terminal 30 does not reduce because the spring pressure of the metal terminal of terminal 30 does not exceed its reversible limit.

Terminal 30 can thus always maintain strong spring pressure. This achieves reliable coupling by contact with a power supply unit of electronic circuit 40 in mobile phone 80. Since no contact failure occurs even if impacts or vibrations are applied to mobile phone 80, a reliable transmission is achieved without any interruption of signals. The reliability and quality of electronic devices such as mobile phones can thus be improved.

### INDUSTRIAL APPLICABILITY

The electro-acoustic converter and electronic device of the present invention is applicable to electronic devices such as video and acoustic equipment, information communications equipment, and game machines whose reliability and quality need to be improved.

1. An electro-acoustic converter comprising:
a magnetic circuit member;
a frame attached to this magnetic circuit member:
a diaphragm attached to an outer periphery of this frame;
a voice coil attached to this diaphragm, a part of the voice coil being disposed in a magnetic gap in the magnetic circuit member;
a terminal coupled to a lead of this voice coil, the terminal being made by bending a single conductive metal plate, and the terminal being brought into contact with a power supply unit of an electronic device in which the electro-acoustic converter is installed by utilizing a spring pressure of this metal plate; and
a stopper provided on the magnetic circuit member, the stopper being configured with a protrusion made of a same material as the magnetic circuit member for restricting bending of the metal plate forming the terminal within a reversible limit of its metal material.

2. The electro-acoustic converter of claim 1, wherein the stopper is provided on a back of a yoke of the magnetic circuit member.

3. The electro-acoustic converter of claim 2, wherein the stopper is integrally formed with the yoke.

4. The electro-acoustic converter of claim 1, wherein the stopper is provided on a back of a lower plate of the magnetic circuit member.

5. The electro-acoustic converter of claim 4, wherein the stopper is integrally formed with the lower plate.

6. The electro-acoustic converter of claim 1, wherein the stopper is covered with an insulator.

7. An electronic device in which the electro-acoustic converter of claim 1 is installed.

8. An electronic device in which the electro-acoustic converter of claim 2 is installed.

9. An electronic device in which the electro-acoustic converter of claim 3 is installed.

10. An electronic device in which the electro-acoustic converter of claim 4 is installed.

11. An electronic device in which the electro-acoustic converter of claim 5 is installed.

12. An electronic device in which the electro-acoustic converter of claim 6 is installed.
